(19) United States
(12) Patent Application Publication
(10) Pub. No.: US 2020/0116129 A1
(43) Pub. Date: Apr. 16, 2020

(54) COMPRESSED AIR DRIVEN ENERGY GENERATION USING APPARENT WIND TURBINES

(71) Applicant: MAGNELAN TECHNOLOGIES INC., Westlake Village, CA (US)

(72) Inventor: Rudolph Oelofse, Seattle, WA (US)

(21) Appl. No.: 16/160,670

(22) Filed: Oct. 15, 2018

(51) Int. Cl. F03D 9/28; F03D 3/04; F03D 7/02; F03D 9/10

(52) U.S. Cl. CPC F03D 9/28; F03D 3/0409; F03D 7/0272; F03D 9/10; F03D 7/028

(57) ABSTRACT

In a method for generating electricity from an apparent wind turbine, a compressor compresses air into compressed air storage to be released at a later time to operate the apparent wind turbine. The method contemplates determining a minimum energy production threshold and a desired energy production threshold, detecting that energy generation from the apparent wind turbine falls below the minimum energy production threshold, and causing the apparent wind turbines to produce at least the minimum energy production threshold.

### FIELD OF THE INVENTION

The field of the invention is energy generation and storage systems.

### BACKGROUND

Conventional wind turbines are subject to a narrow range of operational parameters. For example, even a small conventional wind turbine will typically require wind speeds of at least 3.5 m/s (approx. 8 mph) to start generating power. At the upper end, conventional wind turbines are also limited to operating under wind speeds of no more than approximately 25 m/s (approx. 55 mph) to prevent failure of the wind turbine. In order to prevent conventional wind turbines from failing (i.e., compromising the mechanical integrity of the wind turbine), various techniques including electrical braking and mechanical braking are employed to prevent turbine rotation. However, these techniques can create additional hazards, such as, for example, fires from the heat produced by mechanical brakes to slow down the wind turbine to a lower operational speed.

U.S. Pat. No. 7,900,444 to McBride discloses the storage and recovery of energy using open-air hydraulic pneumatic accumulator and intensifier arrangements in communication with a high-pressure gas storage reservoir. However, McBride does not contemplate redirecting air to the one or more wind turbines at a later time to generate electricity.

U.S. Patent Application Pub. No. 2009/0021012 to Stull discloses the storage of energy harnessed by a conventional windmill as compressed air. Though Stull touches on the use of air to operate an air motor or the vanes of a turbine, Stull does not disclose directing the air back to apparent wind turbines, which are significantly more efficient in generating energy across a wider range of conditions. As such, Stull uses separate energy generation mechanisms to generate energy from compressed air.

U.S. Pat. No. 10,033,314 to Oelofse discloses the generation of energy by a modified Halbach array generator from a wind turbine. However, Oelofse does not disclose using energy from apparent wind turbines to compress air and releasing the compressed air at a later time to act upon the apparent wind turbines to generate energy.

Similarly, U.S. Patent Application Pub. No. 2014/0356180 to Oelefse also discloses an apparent wind turbine for facilitating laminar flow. However, Oelefse does not disclose using the apparent wind turbines to cause a compressor to compress air for later use in generating energy.

McBride, Stull, Oelefse, and all other extrinsic materials discussed herein are incorporated by reference to the same extent as if each individual extrinsic material was specifically and individually indicated to be incorporated by reference. Where a definition or use of a term in an incorporated reference is inconsistent or contrary to the definition of that term provided herein, the definition of that term provided herein applies and the definition of that term in the reference does not apply.

Apparent wind turbines allow for energy generation at significantly lower wind speeds than non-apparent wind turbines, and can also operate in significantly higher wind speeds. As such, apparent wind turbines can capture wind power more efficiently across a significantly wider range of environmental conditions. For example, apparent wind turbines can start generating electricity at 2 m/s (4½ mph), and can possibly withstand wind speeds of at least 50 m/s (112 mph) with no cut-out speed.

However, the significant advantages of apparent wind turbines require more efficient energy storage and generation systems than conventional wind turbine systems.

Thus, apparent wind turbines create a need for systems and methods that can efficiently capture, store, and generate the large amounts of energy produced by apparent wind turbines operating across a wide range of environmental conditions.

### SUMMARY OF THE INVENTION

Among other things, the inventive subject matter provides apparatus, systems, and methods for generating electricity from an apparent wind turbine in which a compressor compresses air into compressed air storage to be released at a later time to operate the apparent wind turbine.

The present invention further contemplates determining a minimum energy production threshold and a desired energy production threshold. Following the determination of thresholds, an energy management system detects that energy generation from the apparent wind turbine falls below the minimum energy production threshold, and, in response, causes the apparent wind turbines to produce at least the minimum energy production threshold.

Various resources, features, aspects and advantages of the inventive subject matter will become more apparent from the following detailed description of preferred embodiments, along with the accompanying drawing figures in which like numerals represent like components.

The present invention advantageously allows compressed air to be used to store energy and run wind turbines to increase energy output.

### BRIEF DESCRIPTION OF THE DRAWINGS

FIG. 1 is a schematic of a distributed apparent wind turbine and compressor system.

FIG. 2 is a schematic of capturing excess energy production as compressed air.

FIG. 3 is a schematic of a method of compressing and releasing compressed air to drive apparent wind turbines to produce electricity.

### DETAILED DESCRIPTION

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

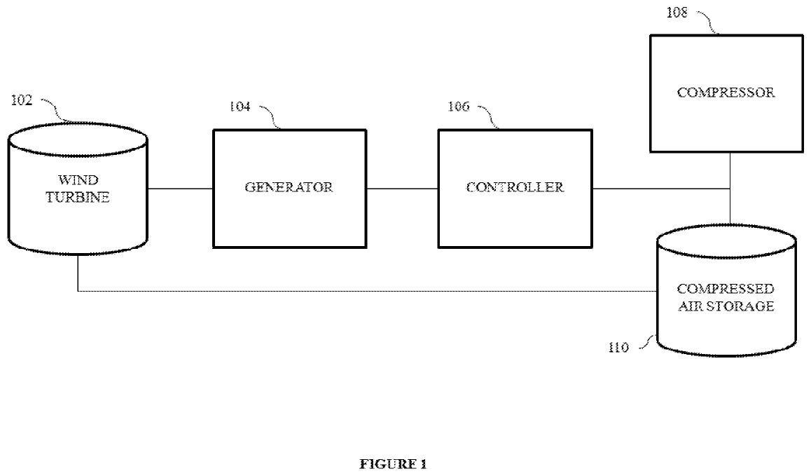

FIG. 1 is a schematic of a distributed apparent wind turbine and compressor system. Distributed apparent wind turbine and compressor system 100 comprises wind turbine 102, generator 104, controller 106, compressor 108, and compressed air storage 110.

Wind turbine 102 can be any suitable wind energy harnessing mechanism. In one embodiment, wind turbine 102 is a vertical axis apparent wind turbine. In another embodiment, wind turbine 102 can be a conventional horizontal axis wind turbine. In yet other embodiments, wind turbine 102 can be a high-altitude generator in which the rotors are carried aloft by various means, including, for example, a balloon or a helicopter, to harness wind energy.

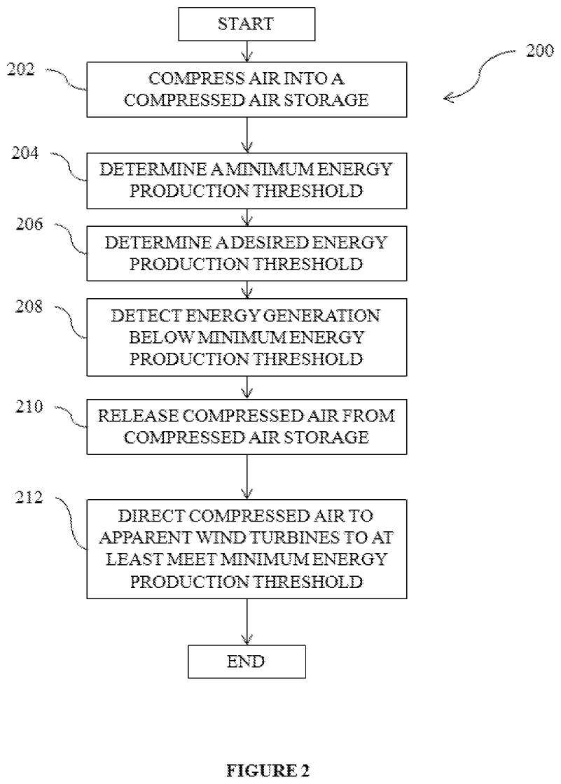

It is contemplated that wind turbine 102 can also comprise non-wind capturing devices working in conjunction with wind turbines. For example, wind turbine 102 can also comprise solar panels which are used in conjunction with wind turbines to provide a relatively constant source of energy. The energy harnessed by non-wind energy harnessing device can also be used to run compressor 108 to store captured energy as compressed air, as further discussed in step 202 of FIG. 2.

Generator 104 can comprise any one or combination of means of converting mechanical energy from a rotor to one or more types of energy. For example, generator 104 can advantageously comprise a Halbach array-based generator to convert the mechanical energy into electrical energy. In another example, generator 104 can redirect mechanical energy from the rotor to act upon compressor 108 to capture mechanical energy as potential energy in the form of compressed air.

Controller 106 can comprise any one or combination of means to control the operation of compressor 108 and/or the operation of compressed air storage 110. For example, controller 106 can be a simple analog circuit to control the operation of compressor 108 and/or the operation of compressed air storage 110, including, for example, detecting and responding to energy generation below a minimum energy production threshold. In other embodiments, controller 106 can comprise a computing device with one or more computer processors that controls the operation of compressor 108 and/or the operation of compressed air storage 110, including, for example, detecting and responding to energy generation falling below a minimum energy production threshold.

Compressor 108 can be any gas compressing device known in the art. For example, compressor 108 can be a reciprocating compressor, a diaphragm compressor, a rotary screw compressor, a rotary vane compressor, a rolling piston compressor, a scroll compressor, an air-bubble compressor, a centrifugal compressor, a mixed-flow compressor, and an axial flow compressor. It is further contemplated that compressor 108 can be powered using any form of energy in the art. In a preferred embodiment, compressor 108 is powered using electrical energy. In alternative embodiments, compressor 108 can be directly driven by harnessed mechanical energy. Compressor 108 can also comprise any combination of compressors working in concert to compress air into compressed air storage 110.

Compressed air storage 110 can be any suitable compressed air storage device or system. In one embodiment, compressed air storage 110 can be a constant volume and variable pressure storage system, which uses a chamber with rigid boundaries to store large amounts of air.

In another embodiment, compressed air storage 110 can be a constant pressure storage, which contains a gas at a constant pressure with variability in the volume. For example, the constant pressure storage system can store air underwater at a constant pressure. More specifically, the hydrostatic pressure from a water column above maintains the pressure of the gas at a constant level. Constant pressure systems can advantageously improve energy density of storage systems, improve the efficiency of machinery utilizing the air pressure by removing variability in outflow pressure, and adapt to a large variety of geographic conditions.

Alternatively, compressed air storage 110 can be stored in one or more small scale compressed storage tanks. For example, compressed air storage 110 can be a system comprising multiple carbon-fiber air storage tanks.

It is contemplated that compressed air storage can be selected based on the situational requirements of distributed apparent wind turbine and compressor system 100.

FIG. 2 is a schematic of a method of compressing and releasing compressed air to drive apparent wind turbines to produce electricity.

Energy management system 200 compresses air into compressed air storage (step 202). Compressed air storage 110 can comprise any apparatus and system used to store air at a higher pressure than the ambient pressure. In one embodiment, compressed air storage 110 can be constant volume and variable pressure storage system, which uses a chamber with rigid boundaries to store large amounts of air. In another embodiment, compressed air storage 110 can be a constant pressure storage, which contains a gas at a constant pressure with variability in the volume. For example, the constant pressure storage system can store air underwater at a constant pressure. More specifically, the hydrostatic pressure from a water column above maintains the pressure of the gas at a constant level. Constant pressure systems can advantageously improve energy density of storage systems, improve the efficiency of machinery utilizing the air pressure by removing variability in outflow pressure, and adapt to a large variety of geographic conditions.

In other embodiments, compressed air storage 110 can be stored in one or more small scale compressed storage tanks. For example, compressed air storage 110 can be a system comprising multiple carbon-fiber air storage tanks.

Energy management system 200 determines a minimum energy production threshold (step 204). It is contemplated that the minimum energy production threshold can be predetermined, periodically determined, and/or constantly determined based on one or more external variables. In an embodiment using a predetermined minimum energy production threshold, the minimum energy production threshold can be the watts generated by a wind turbine at its minimum operational parameters. For example, the minimum operational parameters for a wind turbine can be 8 kilometers per hour (kph) winds at which the wind turbine generates 20 kilowatt-hours.

In an embodiment using a periodically determined minimum energy production threshold, the minimum energy production threshold can reset at regular intervals. For example, the minimum energy production threshold can be reset every month. In embodiments using a constantly determined minimum energy production threshold, energy management system 200 can receive operational information from one or more sources to determine an adjusted minimum energy production threshold. For example, energy management system 200 can receive information from one or more anemometers and process that information using one or more computer processors to determine an adjusted minimum energy production threshold for a group of wind turbines.

It is also contemplated that energy production and storage can be associated with non-electricity-based energy as well. For example, kinetic energy captured by a wind turbine can be directed to run a direct-drive compressor that compresses air into a gas tank. In this example, minimum energy production can be measured in cubic meters per hour (m³/h) of air flow and storage can be limited to a maximum pounds per square inch (PSI).

In alternative embodiments, energy management system 200 does not determine a minimum energy production threshold.

Energy management system 200 determines a desired energy production threshold (step 206).

As with the minimum energy production threshold, it is also contemplated that the desired energy production threshold can be predetermined, periodically determined, and/or constantly determined based on one or more external variables. In an embodiment using a predetermined desired energy production threshold, the desired energy production threshold can be the watts generated by a wind turbine when the wind turbine is at least at 50% capacity of its maximum operational limits. For example, the desired operational parameters for a wind turbine can be 16 kilometers per hour (kph) winds at which the wind turbine generates 50 kilowatt-hours.

In an embodiment using a periodically determined minimum energy production threshold, the minimum energy production threshold can reset at regular intervals. For example, the minimum energy production threshold can be reset every month. In embodiments using a constantly determined minimum energy production threshold, energy management system 200 can receive operational information from one or more sources to determine an adjusted minimum energy production threshold. For example, energy management system 200 can receive information from one or more anemometers and process that information using one or more computer processors to determine an adjusted minimum energy production threshold for a group of wind turbines.

It is also contemplated that energy production and storage can be associated with non-electricity-based energy as well. For example, kinetic energy captured by a wind turbine can be directed to run a direct-drive compressor that compresses air into a gas tank. In this example, minimum energy production can be measured in cubic meters per hour (m³/h) of air flow and storage can be limited to a maximum number of kilograms per square meter (kgf/m³).

In the above examples, it is contemplated that additional variables may be used to determine the desired operation parameters. For example, a priority of maximizing the longevity of the wind turbines can cause the desired energy production level to fall in a range that reduces mechanical wear and tear to the wind turbine.

In alternative embodiment, energy management system 200 does not determine a desired energy production threshold. For example, apparent wind turbines that have a wide operational range

Energy management system 200 detects energy generation below a minimum energy production threshold (step 208).

It is contemplated that energy management system 200 can use any one or more suitable energy measurement devices. In a preferred embodiment, energy management system 200 can use a watt-hour meter to detect a dip in energy generation from a wind turbine. In some embodiments, compressor 108 is directly driven by the kinetic energy captured by a wind turbine. In such embodiments, it is contemplated that energy management system 200 can use kinetic energy and force measuring devices, such as, for example, compression-based force measurement devices.

In some embodiments, energy management system 200 can use a simple analog circuit to detect and respond to energy generation below the minimum energy production threshold. In other embodiments, energy management system 200 can use one or more computer processors to manage the detection and response to energy generation falling below the minimum energy production threshold.

In alternative embodiments, energy management system 200 does not detect energy generation below a minimum energy production threshold. For example, a wind turbine system placed in a location with relatively consistent wind would not require a minimum energy production threshold.

Energy management system 200 releases compressed air from compressed air storage 110 (step 210).

Compressed air storage can comprise any suitable medium for storing compressed gases. As discussed above in step 102, compressed air storage devices can include variable pressure systems and constant pressure systems.

In a preferred embodiment, energy management system 200 releases compressed air from compressed air storage 110 using a controller. The controller can be selected from any suitable controlling mechanism. In one example, the controller can be a computing device comprising one or more computer processors, dynamic random-access memory, and a persistent memory storage device. In another example, the controller can comprise a simple analog circuit that automatically executes an action in response to detecting that the energy production falls below a threshold level.

Energy management system 200 directs compressed air to apparent wind turbines to at least meet the minimum energy production threshold (step 212). It is contemplated that energy management system 200 can direct compressed air to the apparent wind turbines in using any suitable method and system.

In one embodiment, energy management system 200 sends a program instruction directly to a gas release mechanism comprising an actuator that causes gas to be released from one or more compressed air storage devices. For example, energy management system 200 can comprise a computer that is physically coupled to an electronic control mechanism that sends an instruction to an actuator to open a valve in compressed air storage 110.

In another embodiment, energy management system 200 sends program instructions using one or more computer processors over network to a gas release mechanism comprising an actuator that causes gas to be released from one or more compressed air storage devices. For example, energy management system 200 can comprise a computer that is physically coupled to an electronic control mechanism that sends an instruction to an actuator to open a valve in compressed air storage 110 over the Internet.

It is contemplated that the means of directing airflow can comprise any one or more components that facilitate air movement to the apparent wind turbines. For example, compressed air storage 110 can release compressed air through one or more pipes that release the air at an optimal position relative to the apparent wind turbines to increase energy generation. In a related example, the apparent wind turbines can be coupled to air redirection devices, such as, for example, a hood that causes the compressed air to blow more directly on the apparent wind turbines. In yet another example, compressed air storage 110 can be connected to multiple pipelines that redirect air to individual wind turbines or groups of wind turbines.

It is also contemplated that a controller coupled to the wind turbines and compressed air storage 110 can detect when the energy generation rises at or above the minimum energy production threshold and modulate air flow to keep energy generation within a desired range.

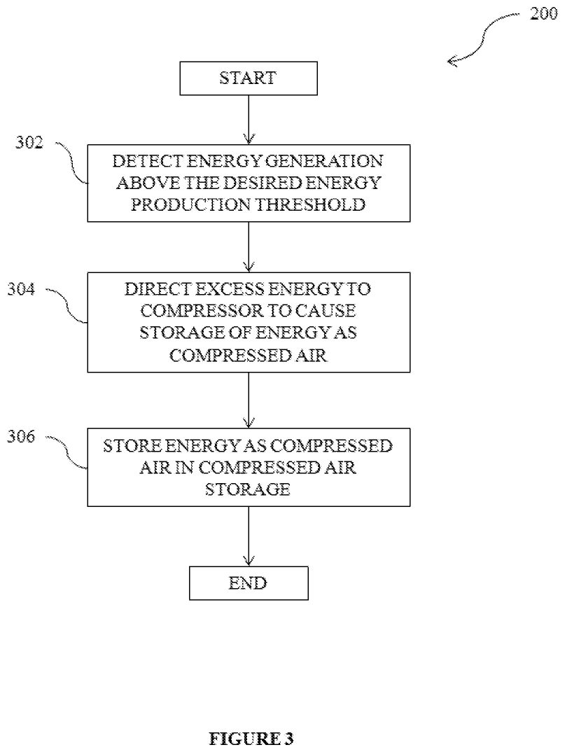

FIG. 3 is a schematic of a method of compressing and releasing compressed air to drive apparent wind turbines to produce electricity.

Energy management system 200 detects energy generation above the desired energy production threshold (step 302).

It is contemplated that energy management system 200 monitors energy generation to determine when the energy generated by the apparent wind turbine rises above the desired energy production threshold. Energy generation can be monitored by any suitable systems, apparatus, and methods. In some embodiments, energy management system 200 may take measures to reduce the energy production below the desired energy production threshold in light of secondary considerations. For example, energy management system 200 can cause a wind turbine to reduce its rotational speed if rising above the desired energy production threshold will cause excessive wear on the wind turbine components.

In one embodiment, energy management system 200 can detect energy generation using a voltmeter. In another embodiment, energy management system 200 can detect energy generation using a multimeter. However, it is contemplated that energy management system 200 can use any means and associated metrics to measure energy generation.

Energy management system 200 directs excess energy to compressor 108 to cause storage of energy as compressed air (step 304).

In embodiments where the kinetic energy of an apparent wind turbine is converted to electrical energy, energy management system 200 directed electricity to a electricity driven compressor to cause compressor 108 to compress air into compressed air storage. In embodiments where the kinetic energy of an apparent wind turbine is converted to mechanical energy, the mechanical energy can, using one or more mechanisms, drive a direct drive compressor to compress air into compressed air storage.

It is contemplated that the energy captured by the apparent wind turbine can be converted to any type of energy to drive the compression of air into compressed air storage 110.

Energy management system 200 stores energy as compressed air in compressed air storage 110 (step 306).

It is contemplated that the compressed air can be used to run the apparent wind turbines when energy production falls below a minimum energy production threshold. In such situations, the release of compressed air can be modulated to meet the desired energy production threshold. Where the desired energy production threshold is a range, the release of compressed air can be modulated to fall within the range of the desired energy production threshold. In situations where the efficiency of the apparent wind turbines is compromised, it is also contemplated that energy management system 200 can dynamically increase the release of compressed air to meet or fall within the range of a desired energy production threshold. For example, if one or more apparent wind turbines fail, then energy management system 200 can increase the compressed air output to meet the desired energy production threshold, but also stay within the range of the desired energy production threshold to avoid negative outcomes, including, for example, excessive wear and tear on the function apparent wind turbines.

It should be noted that while the description discusses embodiments comprising computer-based controllers, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for generating electricity from an apparent wind turbine, comprising:
compressing air into a compressed air storage; and
directing the compressed air from the compressed air storage to operate the apparent wind turbine.

2. The method of claim 1, further comprising:
determining a minimum energy production threshold and a desired energy production threshold;
detecting that energy generation from the apparent wind turbine falls below the minimum energy production threshold; and
causing the apparent wind turbines to produce at least the minimum energy production threshold.

3. The method of claim 2, further comprising dynamically determining the minimum energy production threshold.

4. The method of claim 2, further comprising dynamically determining the desired energy production threshold.

5. The method of claim 1, wherein the step of compressing air into compressed air storage is executed by a compressor that is driven directly by the apparent wind turbine.

6. The method of claim 5, wherein the step of compressing utilizes a compressor selected from the group consisting of: a reciprocating compressor, a diaphragm compressor, and a rotary vane compressor.

7. The method of claim 1, further comprising using an electricity demand level to dynamically determine the desired energy production threshold.

8. The method of claim 7, further comprising adjusting a flow rate of the compressed air from the compressed air storage in response to changes in the electricity demand level.

9. The method of claim 7, further comprising:
detecting that the electricity generation from the apparent wind turbines rises above the desired energy production threshold; and
directing excess energy to a compressor to cause compression of air into the compressed air storage.

10. The method of claim 1, wherein the minimum energy production threshold is automatically determined by one or more computer processors.

11. The method of claim 1, wherein the desired energy production threshold is automatically determined by one or more computer processors.

12. A system for generating electricity from apparent wind turbines using stored compressed air, the system comprising:
a compressor coupled to the apparent wind turbines;
a compressed air storage coupled to the compressor using a first air conduit, wherein the compressor compresses air to be stored in the compressed air storage; and
an air outlet coupled to the compressed air storage using a second air conduit, wherein the compressed air storage is configured to release the stored compressed air out through the air outlet via the second air conduit.

13. The system of claim 12, wherein the compressor is selected from the group consisting of: a reciprocating compressor, a diaphragm compressor, and a rotary vane compressor.

14. The system of claim 12, further comprising:
a battery operatively coupled to the apparent wind turbines and the compressor to store excess electrical energy, wherein the battery is further configured to:
receive the excess electrical energy from the apparent wind turbines, and
deliver the excess electrical energy to the compressor.

15. The system of claim 12, further comprising:
an analog circuit, wherein the analog circuit is configured to:
redirect energy to cause the compressor to compress air, and
cause the compressed air storage to release the stored compressed air to operate the apparent wind turbines.

16. The system of claim 12, further comprising:
one or more computer processors, wherein the one or more computer processors are configured to:
redirect energy above a desired energy production threshold to cause the compressor to compress air, and
cause the compressed air storage to release the stored compressed air to operate the apparent wind turbines.
